(19) United States
(12) Patent Application Publication
(10) Pub. No.: US 2026/0049585 A1
(43) Pub. Date: Feb. 19, 2026

(54) ANNULAR DISCHARGE VENTURI BOOSTER ASSEMBLY

(71) Applicants: Jack Lasheff, Libertyville, IL (US); Steve Lasheff, Mount Prospect, IL (US)

(72) Inventors: Jack Lasheff, Libertyville, IL (US); Steve Lasheff, Mount Prospect, IL (US)

(21) Appl. No.: 19/021,579

(22) Filed: Jan. 15, 2025

Related U.S. Application Data
(63) Continuation-in-part of application No. 18/803,317, filed on Aug. 13, 2024, now abandoned.

(51) Int. Cl. F02M 19/08; B01F 25/312; B01F 101/00

(52) U.S. Cl. CPC F02M 19/08; B01F 25/31242; B01F 2101/503

(57) ABSTRACT

An annular discharge venturi booster assembly includes a tube, a pair of supports, and a venturi booster insert. The pair of supports are attached to and extend in opposite directions from the tube and each includes an arm and a flange insertable into a slot in venturi of a carburetor. The tube includes an annular fuel channel and one arm includes a fuel line connecting the annular fuel channel to a fuel supply. A lower portion of the tube projects beyond a bottom surface of the flanges. The venturi booster insert is inserted into the tube and suspended in a venturi of a carburetor and includes an air intake portion, a fuel feed portion that includes a plurality of orifices in communication with the annular fuel channel, and an outlet portion. The fuel feed portion includes an interior surface having a continuous curvature up to a sharp perimeter edge.

### CROSS-REFERENCE TO RELATED APPLICATIONS

This application is a continuation-in-part of U.S. application Ser. No. 18/803,317 filed Aug. 13, 2024, which is incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to venturi boosters and more particularly pertains to a new annular discharge venturi booster assembly for increasing performance, increasing engine signal, and reducing throttle hesitation for large, high compression engines. In the world of competitive drag racing and high performance vehicles, venturi booster inserts are placed inside a support structure that is seated across the main venturi air intakes of a carburetor. The venturi booster insert allows the signal or pressure drop at the minor diameter of the main venturi to be increased as measured at the minor diameter of the booster venturi. Improvements to the venturi booster that result in lower racing times are desirable. Since in drag racing the times are measured in thousandths of a second, an improvement of tenths of a second are very significant and substantial.

### (2) Description of Related Art Including Information Disclosed Under 37 CFR 1.97 and 1.98

The prior art relates to venturi boosters, wherein the bottom edge of the tube that holds the venturi booster insert, and thus the bottom edge of the venturi booster insert, is even with the bottom edges of the flanges of support arms, and thus positioned at the narrowest point or section of the main venturi. The prior art, as best understood, does not disclose a venturi booster assembly in which the tube and the venturi booster insert are positioned to project beyond the lowermost portion of the support arms and thus beyond the narrowest point or section of the main venturi.

### BRIEF SUMMARY OF THE INVENTION

An embodiment of the disclosure meets the needs presented above in an annular discharge venturi booster assembly generally comprising a tube, a pair of supports, and a venturi booster insert. The pair of supports are attached to and extend in opposite directions from the tube and each includes an arm and a flange insertable into a slot in venturi of a carburetor. The tube includes an annular fuel channel and one of the arms includes a fuel line therein to connect the annular fuel channel to a fuel supply. A lower portion of the tube projects beyond a bottom surface of each of the flanges. The venturi booster insert is designed to be inserted into the tube and suspended in a middle of a venturi of a carburetor and includes an air intake portion, a fuel feed portion that includes a plurality of orifices in communication with the annular fuel channel, and an outlet portion. The fuel feed portion includes an interior surface having a continuous curvature up to a sharp perimeter edge.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an annular discharge venturi booster assembly according to an embodiment of the disclosure.

FIG. 2 is a front view of an embodiment of the disclosure.

FIG. 3 is a side view of an embodiment of the disclosure.

FIG. 4 is a cross-sectional view of an embodiment of the disclosure.

FIG. 5 is a cross-sectional view of an example of a standard annular discharge venturi booster assembly.

FIG. 6 is a perspective view of an embodiment of the disclosure in use.

FIG. 7 is a cross-sectional view of an embodiment of the disclosure in use.

FIG. 8 shows an alternative embodiment of the disclosure.

### DETAILED DESCRIPTION OF THE INVENTION

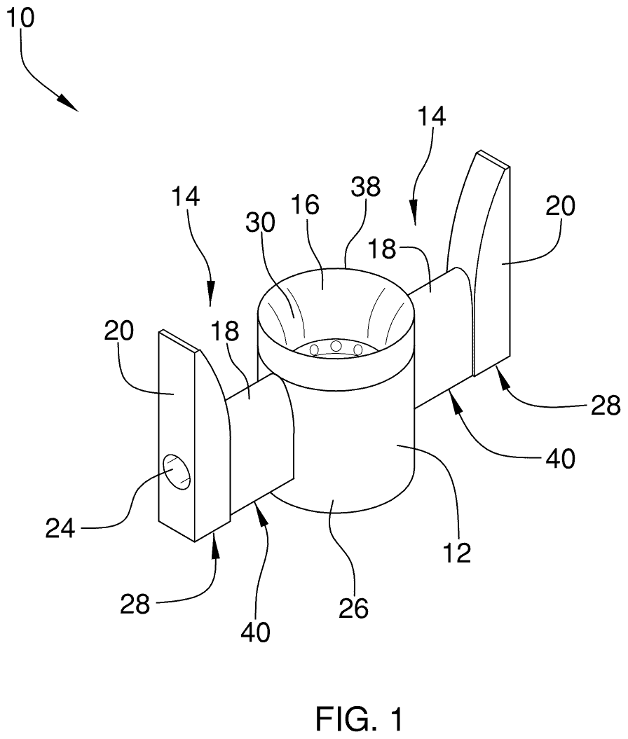

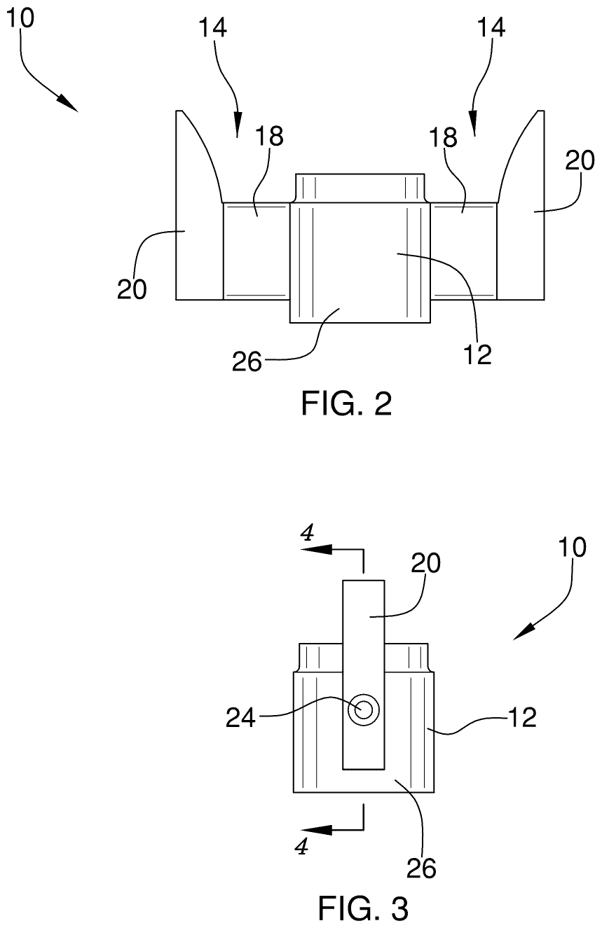

With reference now to the drawings, and in particular to FIGS. 1 through 8 thereof, a new annular discharge venturi booster assembly embodying the principles and concepts of an embodiment of the disclosure and generally designated by the reference numeral 10 will be described.

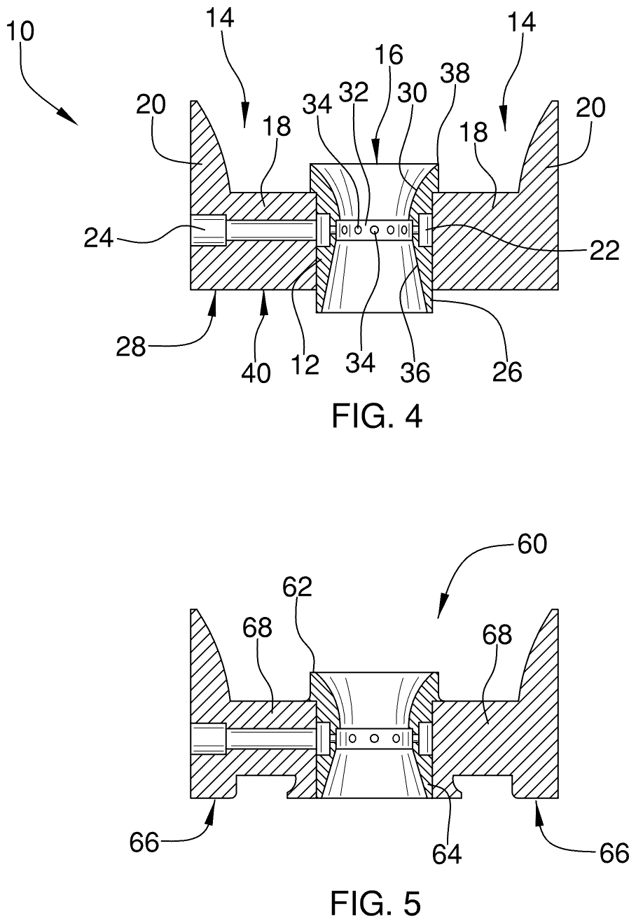

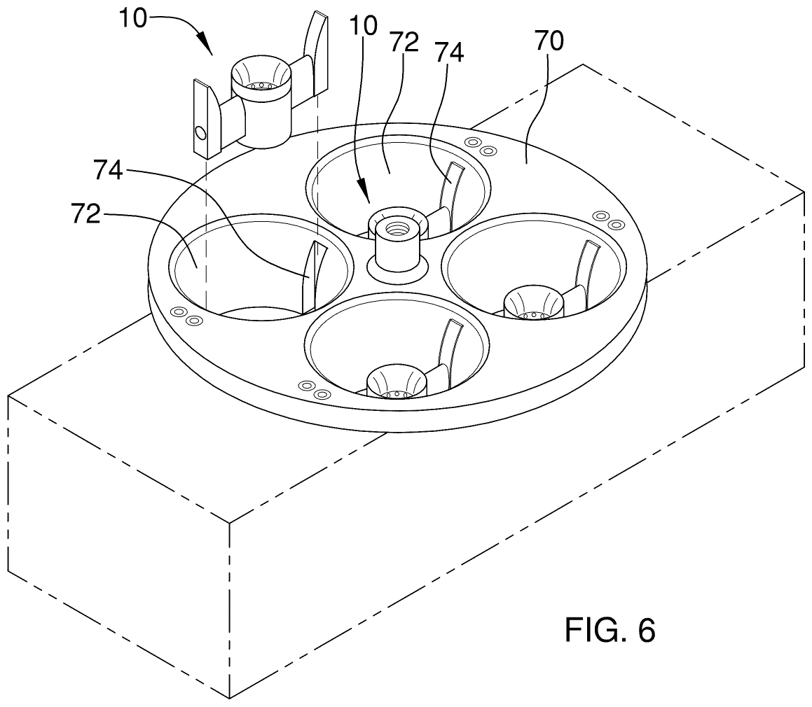

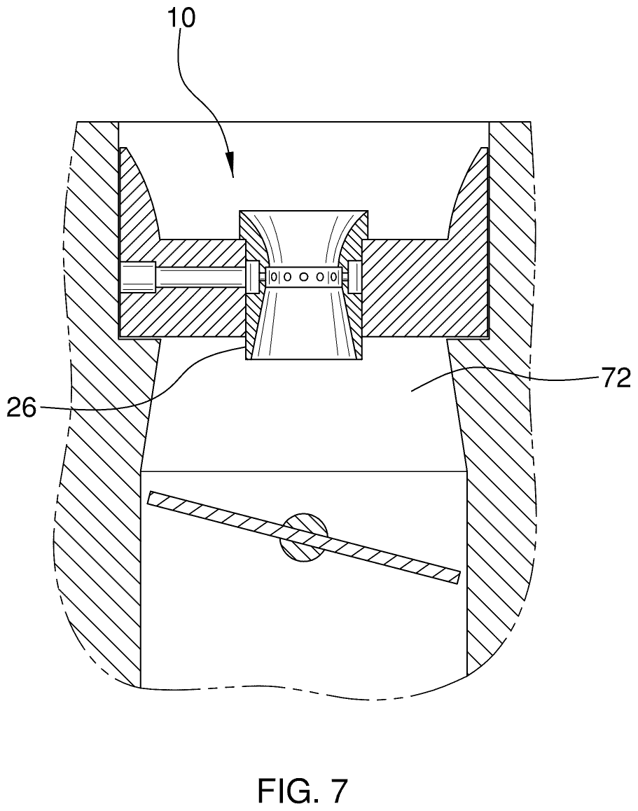

As best illustrated in FIGS. 1 through 8, the annular discharge venturi booster assembly 10 generally comprises a tube 12, a pair of supports 14, and a venturi booster insert 16. As shown in FIG. 1, the pair of supports 14 are attached to and extend in opposite directions from the tube 12 and each includes an arm 18 and a flange 20 insertable into a slot 74 in main venturi 72 of a carburetor 70. As best seen in FIG. 4, the tube 12 includes an annular fuel channel 22 and one of the arms 18 includes a fuel line 24 therein to connect the annular fuel channel 22 to a fuel supply (not shown). A lower portion 26 of the tube 12 projects beyond a bottom surface 28 of each of the flanges 20. The venturi booster insert 16 is designed to be inserted into the tube 12 and suspended in a middle of a main venturi 72 of a carburetor 70, such as shown in FIG. 6. The venturi booster insert 16 includes an air intake portion 30, a fuel feed portion 32 that includes a plurality of orifices 34 in communication with the annular fuel channel 22, and an outlet portion 36. The fuel feed portion 32 includes an interior surface having a continuous curvature up to a sharp perimeter edge 38. To further explain, some existing annular discharge venturi booster systems 60, such as the example shown in FIG. 5, curve to a flat lip 62, not a sharp perimeter edge 38. In addition, the bottom of the venturi section 64 does not project past the lowermost portion 66 of the supporting arm structures 68. The annular discharge venturi booster assembly 10 improves on this design by widening the air intake portion 30 by extending the opening to the sharp perimeter edge 38. In addition, the lower portion 26 of the tube 12 projects beyond the bottom surface 28 of each of the flanges 20, and thus the venturi booster insert 16 projects lower into a main venturi 72 of a carburetor 70 beyond the narrowest portion of the main venturi 72. This modified positioning can be seen in FIG. 7.

As shown in FIG. 4, the bottom surface 28 of the flanges 20 is coplanar with a bottom edge 40 of each of the arms 18.

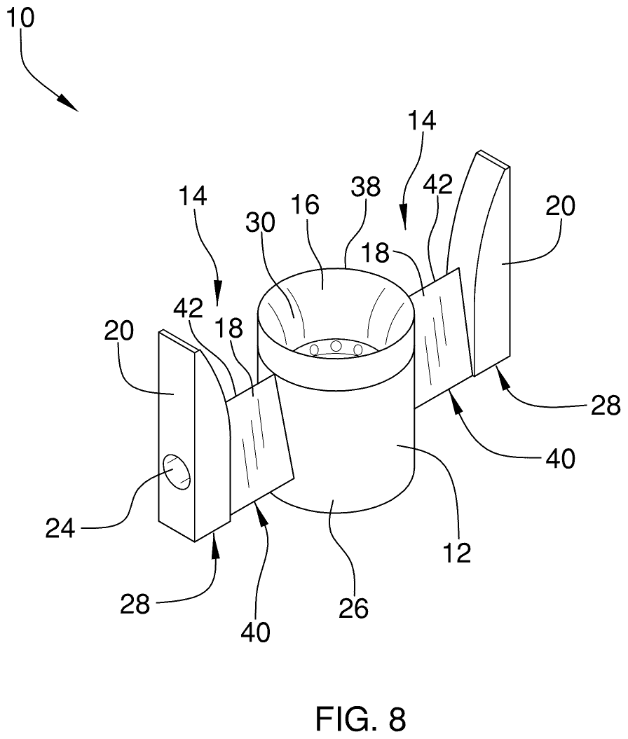

In the embodiment shown in FIG. 8, each of the arms 18 tapers to a sharp edge 42. In FIG. 1 the arms 18 curve to a slightly rounded top, whereas in FIG. 8 the arms 18 have flat surfaces that taper to the sharp edge 42. This design can improve aerodynamics and enhance air flow. In one possible embodiment, the arms 18 could have a combination of a curved surface that transitions into a flat surface that tapers to the sharp edge 42.

The lower portion 26 of the tube 12 projects approximately 0.1700 to 0.2050 of an inch, or 0.1700 to 0.2050 of an inch, or approximately 0.1875 of an inch. The sharp perimeter edge 38 is circular and has a diameter of approximately 0.5525 to 0.5800 of an inch, or 0.5525 to 0.5800 of an inch, or approximately 0.5675 of an inch. The air intake portion 30 tapers inwardly toward the fuel feed portion 32 to a diameter of approximately 0.3000 to 0.3250 of an inch, or 0.3000 to 0.3250 of an inch, or approximately 0.3125 of an inch.

The inventors unexpectedly found that these modifications or deviations from a standard design, such as an air intake mouth having a maximum diameter of approximately 0.5050 that tapers to a smallest diameter of approximately 0.2500, wherein the bottom of the venturi section 64 does not project past the lowermost portion 66 of the supporting arm structures 68, resulted in a stronger signal and very little throttle hesitation. As a result, drag or racing times over 60 feet were reduced by about 0.1000 of a second. While this is a rather small amount of time generally speaking, this is a massive decrease in the world of racing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An annular discharge venturi booster assembly comprising:
a tube and a pair of supports attached to and extending in opposite directions from said tube and each comprising an arm and a flange insertable into a slot in a main venturi of a carburetor, wherein said tube comprises an annular fuel channel and one of said arms comprises a fuel line therein to connect said annular fuel channel to a fuel supply, and wherein each of said arms tapers to a sharp edge; and
a venturi booster insert configured to be inserted into said tube and suspended in a middle of a main venturi of a carburetor and comprising an air intake portion, a fuel feed portion comprising a plurality of orifices in communication with said annular fuel channel, and an outlet portion.

2. The annular discharge venturi booster assembly of claim 1, wherein a lower portion of said tube projects beyond a bottom surface of each of said flanges.

3. The annular discharge venturi booster assembly of claim 1, wherein said fuel feed portion comprises an interior surface having a continuous curvature up to a sharp perimeter edge.

4. The annular discharge venturi booster assembly of claim 1, wherein said lower portion of said tube projects approximately 0.1700 to 0.2050 of an inch.

5. The annular discharge venturi booster assembly of claim 1, wherein said lower portion of said tube projects 0.1700 to 0.2050 of an inch.

6. The annular discharge venturi booster assembly of claim 1, wherein said lower portion of said tube projects approximately 0.1875 of an inch.

7. The annular discharge venturi booster assembly of claim 1, wherein said bottom surface of said flanges is coplanar with a bottom edge of each of said arms.

8. The annular discharge venturi booster assembly of claim 1, wherein said sharp perimeter edge is circular and has a diameter of approximately 0.5525 to 0.5800 of an inch.

9. The annular discharge venturi booster assembly of claim 1, wherein said sharp perimeter edge is circular and has a diameter of 0.5525 to 0.5800 of an inch.

10. The annular discharge venturi booster assembly of claim 1, wherein said sharp perimeter edge is circular and has a diameter of approximately 0.5675 of an inch.

11. The annular discharge venturi booster assembly of claim 1, wherein said air intake portion tapers inwardly toward said fuel feed portion to a diameter of approximately 0.3000 to 0.3250 of an inch.

12. The annular discharge venturi booster assembly of claim 1, wherein said air intake portion tapers inwardly toward said fuel feed portion to a diameter of 0.3000 to 0.3250 of an inch.

13. The annular discharge venturi booster assembly of claim 1, wherein said air intake portion tapers inwardly toward said fuel feed portion to a diameter of approximately 0.3125 of an inch.

14. The annular discharge venturi booster assembly of claim 2, wherein said fuel feed portion comprises an interior surface having a continuous curvature up to a sharp perimeter edge.

15. The annular discharge venturi booster assembly of claim 14, wherein said bottom surface of said flanges is coplanar with a bottom edge of each of said arms.

16. The annular discharge venturi booster assembly of claim 15, wherein:
said lower portion of said tube projects 0.1700 to 0.2050 of an inch;
said sharp perimeter edge is circular and has a diameter of 0.5525 to 0.5800 of an inch; and
said air intake portion tapers inwardly toward said fuel feed portion to a diameter of 0.3000 to 0.3250 of an inch.
